(19) United States
(12) Patent Application Publication
(10) Pub. No.: US 2020/0091852 A1
(43) Pub. Date: Mar. 19, 2020

(54) CIRCUIT ARRANGEMENT AND METHOD FOR OPERATING A CIRCUIT ARRANGEMENT

(71) Applicant: MARTIN KFZ-TECHNIK GMBH, Nordlingen (DE)

(72) Inventor: Jurgen FRANK, Oberndorf am Lech (DE)

(73) Assignee: MARTIN KFZ-TECHNIK GMBH, Nordlingen (DE)

(21) Appl. No.: 16/565,586

(22) Filed: Sep. 10, 2019

(30) Foreign Application Priority Data
Sep. 18, 2018 (DE) 102018122913.5

(51) Int. Cl. H02P 25/26

(52) U.S. Cl. CPC H02P 25/26

(57) ABSTRACT

A circuit arrangement for generating a three-phase rotating field at least at an electrical consumer including at least one mains voltage input including a single-phase alternating current, a first phase strand connected to the mains voltage input and the electrical consumer, whose transported voltage includes a first outer conductor, a second phase strand, whose transported voltage corresponds to a second outer conductor, an energy storage, a switching element, through which the energy storage can be connected via a third phase strand for generating a third outer conductor, and a control unit that can detect at least one trigger point of the first phase strand and the switching element can be actuated at least at a detected trigger point of the first outer conductor of the first phase strand to close or open the third phase strand and to generate the third outer conductor.

### CROSS REFERENCE TO RELATED APPLICATIONS

This application claims priority to Germany application DE 10 2018 122 913.5, filed Sep. 18, 2018, which is incorporated by reference in its entirety.

### FIELD OF THE INVENTION

The invention relates to a circuit arrangement and method for operating a circuit arrangement.

### BACKGROUND OF THE INVENTION

Circuit arrangements and methods for operating such circuit arrangements are known from the prior art in various forms. These serve, for example, to generate a three-phase rotating field from a single-phase network.

In such a three-phase rotating field, the individual phase angles run in each case 120° out of phase with each other. Such circuit arrangements can be used, for example, to connect asynchronous motors to a single-phase network.

Such circuit arrangements include, for example, so-called Steinmetz circuits or specially made condenser machines for 90° rotating fields.

However, the circuit arrangements known from the prior art have high starting currents and poor efficiencies. In addition, these include, in particular the example of Steinmetz circuits, an electric rotating field of <90°.

### SUMMARY OF THE INVENTION

The object of an embodiment of the invention is to propose a circuit arrangement and a method for operating a circuit arrangement, by which an improved three-phase rotating field can be generated.

This object is achieved by a circuit arrangement for generating a three-phase rotating field at least at an electrical consumer, such as an asynchronous motor, comprising at least one mains voltage input comprising a single-phase alternating current, with at least one first phase strand connected to the mains voltage input and the electrical consumer, whose transported voltage comprises a first outer conductor L1, with at least one second phase strand connected to the mains voltage input and the electrical consumer, whose transported voltage corresponds to a second outer conductor L2 120° offset from the first outer conductor L1, with at least one energy storage, which is connected to the mains voltage input and in which at least temporary electrical energy can be stored, with at least one switching element, through which the energy storage can be connected via a third phase strand with the electrical consumer for generating a third outer conductor L3, and with at least one control unit, by means of which at least one trigger point of the first phase strand can be detected and the switching element can be actuated at least at a detected trigger point of the first outer conductor L1 of the first phase strand to close or open the third phase strand and to generate the third outer conductor.

The trigger point comprises an angle of the first outer conductor. Here, the trigger point may include a zero crossing or other angle.

Characterized in that the switching element can be controlled by the control unit such that when detecting a trigger point of the first outer conductor of the first phase strand is controllable, in order to generate in a third phase strand of a third outer conductor L3, the third outer conductor L3 of the third phase strand runs after the first outer conductor L1 by 240°. As a result, three correct outer conductors can be generated at 120° phase angle each, so that the second outer conductor L2 runs after the first outer conductor L1 by 120°, and the third outer conductor L3 runs after the first outer conductor L1 by 240°.

In addition, lower start-up currents and lower losses are present due to the aforementioned structure. Furthermore, such a circuit arrangement can be operated without an acoustically perceptible or at least reduced hum.

Finally, a higher motor performance of the asynchronous motor can be generated by the inventive circuit arrangement compared to the prior art.

The mains voltage input may be a single-phase mains voltage L/N, for example 230 V and 50 Hz. This can include a luminous flux network if the circuitry is installed in a domestic appliance, industrial machine and/or motor vehicle.

The circuitry may be an element of any electrical circuit to convert a single-phase mains voltage to a three-phase. The electrical consumer may be an asynchronous motor.

It proves to be advantageous if the control unit comprises at least one sensor means, at least one calculating unit and/or at least one signal generator controllable by the calculating unit, by which a signal for opening or closing the switching element can be generated and passed and/or sent to the switching element. This allows for a timely control of the generation of the third outer conductor L3 in the third phase strand offset 240° to the first outer conductor L1.

In a development of the last-mentioned embodiment, it proves to be advantageous if at least one sensor means comprises a synchronization circuit, such as trigger, voltage monitor trigger, operational amplifier, discrete transistor, switching regulator and/or network analyzer, by which at least one negative/positive transition of at least the first outer conductor L1 of the first phase strand can be detected.

Through the synchronization circuit phase angle, phase angles are detectable at least on the first outer conductor L1 of the first phase strand at 0°/positive, or 180°/negative or corresponding to other fixed positions. These negative/positive transitions thus obtained can be forwarded to the calculating unit.

In addition, time intervals of the so-called trigger points can be detected by the synchronization circuit and a network frequency can be determined. This is calculable by the formal relationship:

f=1/T.

In words: Mains frequency equals 1 divided by time interval in seconds.

This makes it possible to react flexibly to mains frequency fluctuations.

Moreover, it proves to be advantageous if the calculating unit comprises a CPU and/or if the signal generator controllable by the calculating unit comprises a sinoidal pulse width modulation, wherein the calculating unit has an algorithm stored in the calculating unit for driving the signal generator, which comprises a sine function or relies on tables stored in the calculating unit.

The algorithm or the tables can be stored in the calculating unit or in a memory unit functionally assigned to the calculating unit. Through the algorithm, or through the tables, the sinoidal pulse width modulation is calculable and the signal generator can be controlled accordingly.

In addition, a direction of rotation change (left/right rotation) can be stored in the calculating unit. Furthermore, in one embodiment of the calculating unit, an evaluation and adaptation to the mains frequency as well as an adaptation to mains frequency fluctuations can be detected and compensated.

Furthermore, it is conceivable that a current limit, in particular a start-up and stop function, can be stored in the calculating unit. Finally, in the calculating unit, a torque control for power reduction in simple speed controls (fans, drives or the like) may be provided.

Moreover, in one embodiment of the circuit arrangement it is provided that the switching element has an output stage with at least one driver, such as transistor, in particular bipolar transistor with insulated gate electrode, metal oxide semiconductor field effect transistor (MOSFET), bipolar transistor, SiC MOSFET (Silicon Carbide) and/or BIMOSFET.

Through the switching element, in particular through the output stage, weak control signals of the computing unit, in particular the CPU, are converted into high-power and high-voltage signals.

In addition, it proves to be advantageous if the energy storage comprises at least one energy storage means, such as a battery and/or capacitor and/or if the energy storage comprises at least one transformer.

Through the energy storage electrical energy can be stored, or buffered, which is available at the time of performance of the third outer conductor to produce the third outer conductor L3. At this time, for example, no energy can be removed from the mains voltage, since this is at a lower voltage level at this time.

The battery may also include, for example, a vehicle battery.

Furthermore, it proves to be advantageous if the energy storage comprises at least one rectifier such as a diode arranged between the first phase strand and energy storage means and/or between the second phase strand and energy storage means.

In one embodiment of the circuit arrangement, for example, an energy storage means is provided, which is connected via a single rectifier to the first phase strand. In this case, the storage means can be charged with electrical energy exclusively via the first phase strand.

In a further embodiment of the circuit arrangement, two energy stores are provided, one for the positive and one for the negative half-wave, which are connected in series with the D2 two-pulse doubler circuit or Greinacher circuit.

Finally, it proves to be advantageous if the circuit arrangement comprises at least one measuring element arranged between the switching element and the electrical consumer, which measuring element is connected or can be connected, in particular directly or indirectly, to the calculating unit.

By providing a measuring means, for example, a current within the circuit arrangement can be detected and limited in cooperation with the control unit and a start-up current when switching on the circuit can be detected and preprogrammed.

In addition, the object is achieved by a method for operating a circuit arrangement for generating a three-phase rotating field having at least one of the aforementioned features and with these steps:
a. Commissioning of the circuit arrangement by switching on or connecting the mains voltage input;
b. Possibly charging the energy storage by the mains voltage input;
c. Detecting a suitable trigger point, such as a negative/positive transition at least on the first outer conductor of the first phase strand by the sensor means of the control unit;
d. Calculating an opening time of the switching element, in which a third outer conductor offset by 240° to the first outer conductor by the energy of the energy storage device can be generated by the calculating unit of the control unit and opening or closing of the switching element by a signal generator of the control unit when reaching the opening or closing time.

In a further development of the method, the following steps are provided:
a. Depositing a run-up current in the calculating unit and/or detecting the run-up current by the measuring means;
b. Limiting the run-up current through the control unit.

Further features, details and advantages of the invention will become apparent from the appended claims, the drawings and the following description of two preferred embodiments of the circuit arrangement and of the method for operating a circuit arrangement.

### BRIEF DESCRIPTION OF THE DRAWINGS

The drawing shows:

FIG. 1 is a schematic, electrical circuit diagram of a first embodiment of the circuit arrangement;

FIG. 2 is a schematic, electrical circuit diagram of a second embodiment of the circuit arrangement;

FIG. 3 is a schematic flow diagram of the method according to the invention.

### DETAILED DESCRIPTION OF THE INVENTION

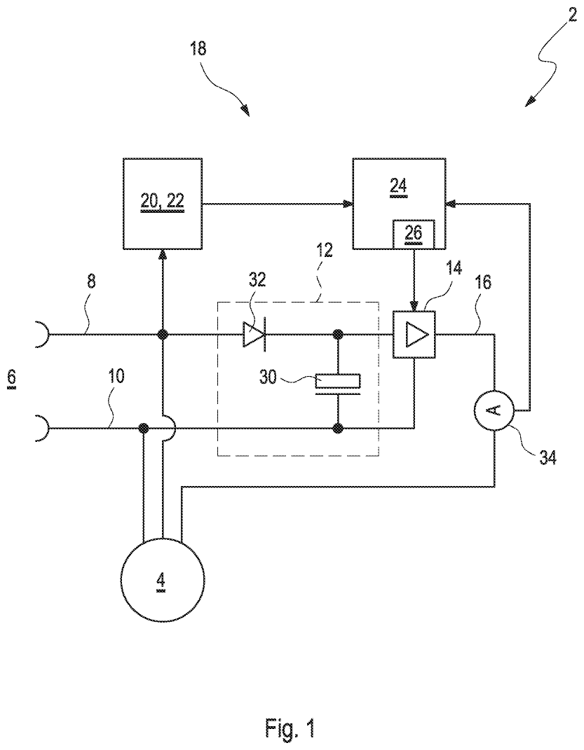

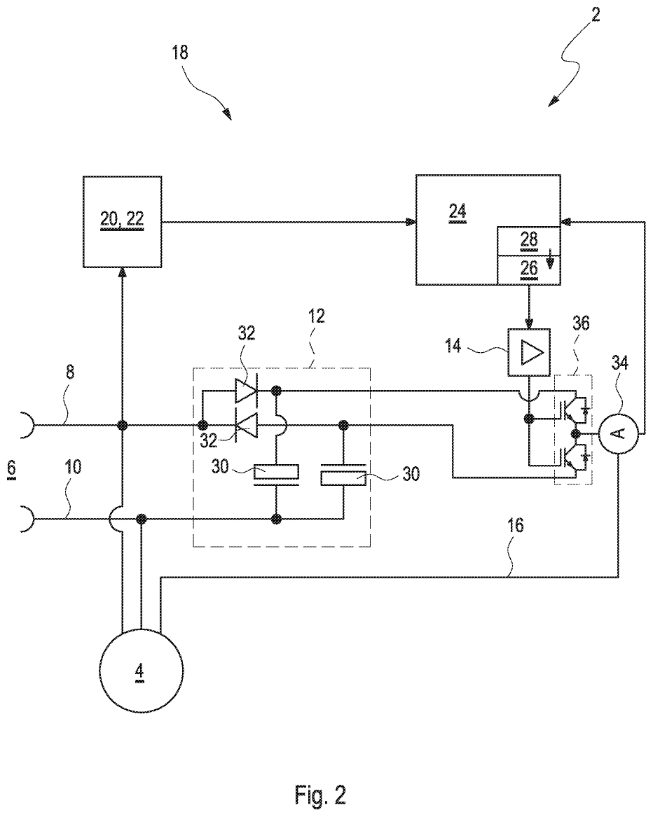

FIGS. 1 and 2 each show an electrical circuit diagram of embodiments of a circuit arrangement provide the reference numeral 2. The circuit arrangement 2 is used to generate a three-phase rotating field. This is generated on an electrical consumer 4, such as an induction motor.

In the exemplary embodiments shown in the figures, the circuit arrangement 2 comprises a mains voltage input 6. From the mains voltage input 6, a first phase strand (=u1) 8 leads to the electrical consumer 4. In the first phase strand 8, the voltage carried in the first phase strand 8 comprises a first outer conductor L1. In addition, the circuit arrangement 2 comprises a second phase strand (=v1) 10 connected to the mains voltage input 6 and the electrical consumer 4, whose transported voltage comprises a second outer conductor offset by 120° from the first outer conductor of the first phase strand 8.

In addition, the circuit arrangement 2 comprises an energy storage 12, which is connected to the mains voltage input 6 and in which at least for a short time electrical energy can be stored.

In addition, the circuit arrangement 2 in the exemplary embodiments shown in FIGS. 1 and 2 in each case comprises a switching element 14, by means of which the energy storage 12 can be connected to the electrical consumer 4 via a third phase strand 16.

In addition, in the embodiments shown in FIGS. 1 and 2, the circuit arrangement 2 comprises a control unit 18, by which at least one fixed trigger point of the first phase strand 8 is detected and the switching element 14 is controllable with least one detected trigger point on the first outer conductor of the first phase strand 8 for closing of the third phase strand 16 and for generating a third outer conductor.

The two exemplary embodiments of the circuit arrangement 2 according to FIGS. 1 and 2 are common in each case in that the control unit 18 in each case comprises a sensor means 20. The sensor means 20 comprises in the embodiments shown in the figures, a synchronization circuit 22, such as a trigger, through which at least one positive/negative transition at least on the first outer conductor of the first phase strand 8 can be detected.

In addition, the control units 18 each comprise a calculating unit 24 and a signal generator 26 that can be controlled by the calculating unit 24.

Through the signal generator 26, a signal for opening or closing of the switching element 14 can be generated and can be conducted and/or transmitted to the switching element 14. The signal generator 26 may be, for example, a pulse-width modulation generator.

The computing units 24 of the control units 18 may comprise a CPU in which an algorithm or a table 28 can be stored.

FIG. 1 shows a first exemplary embodiment of the circuit arrangement 2, in which the energy storage 12 comprises an energy storage means 30 connected to the first phase strand 8. Between the energy storage means 30 and the first phase strand 8, a rectifier 32, such as diode, is arranged. As a result, the energy storage means 30 of the energy storage 12 of the first embodiment is always charged with electrical energy when the first phase strand 8 is located in an outer conductor deviating from a zero phase.

In addition, in the exemplary embodiment shown in FIG. 1, a measuring means 34 is provided which is connected to the calculating unit 24.

FIG. 2 shows an exemplary embodiment of the circuit arrangement 2, in which the energy storage 12 comprises two energy storage means 30 and two rectifiers 32. As a result, an operating voltage of +/−310V is generated and temporarily stored by this D2 two-pulse doubler circuit.

In addition, the exemplary embodiment according to FIG. 2 comprises an output stage 36, which can be functionally assigned to the switching element 14 and can be converted into high-power and voltage-high signals by the weak control signals of the calculating unit 24.

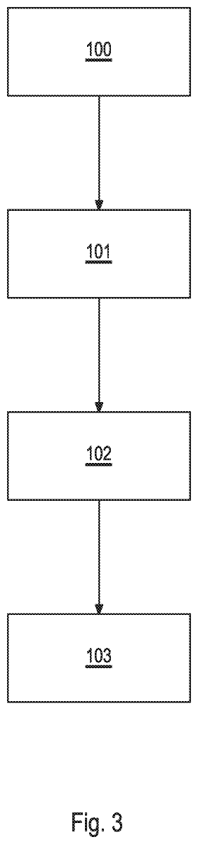

FIG. 3 shows a schematic flow diagram of the mode of operation of the circuit arrangement 2. With the aid of the circuit arrangements 2 of FIGS. 1 and 2, the method is described below:

In a first step 100, the circuit arrangement 2 is put into operation. This takes place by switching on or connecting the mains voltage input 6.

In a subsequent step 101, the energy storage 12 is charged by the mains voltage. This takes place in each case as long as the respective outer conductors are not in their zero crossing.

In a further step 102, a negative/positive transition, such as zero crossing of the mains voltage is detected by the sensor means 20 of the control unit 18.

Following this, in a step 103, a closing and opening time of the switching element 14 is calculated by the computing unit 24, at which a third outer conductor offset by 240° with respect to the first outer conductor L1 can be generated by the energy of the energy store 12. Upon reaching this closing or opening time, the switching element 14 is closed or opened, which takes place by the signal generator 26 of the control unit 18.

The features of the invention disclosed in the foregoing description, in the claims and in the drawing, may be essential both individually and in any combination in the realization of the invention in its various embodiments.

### REFERENCE LIST

2 circuit arrangement
4 electrical consumers
6 mains voltage input
8 first phase strand
10 second phase strand
12 energy store
14 switching element
16 third phase strand
18 control unit
20 sensor means
22 synchronization circuit
24 calculating unit
26 signal generator
28 table
30 energy storage means
32 rectifier
34 measuring means
36 output stage

1. A circuit arrangement for generating a three-phase rotating field at least at an electrical consumer comprising:
at least one mains voltage input comprising a single-phase alternating current,
at least one first phase strand connected to the mains voltage input and the electrical consumer, whose transported voltage comprises a first outer conductor,
at least one second phase strand connected to the mains voltage input and the electrical consumer, whose transported voltage corresponds to a second outer conductor 120° offset from the first outer conductor,
at least one energy storage, which is connected to the mains voltage input and in which at least temporary electrical energy is able to be stored,
at least one switching element through which the energy storage is able to be connected via a third phase strand with the electrical consumer for generating a third outer conductor, and
at least one control unit by means of which at least one trigger point of the first phase strand is able to be detected and the switching element is able to be actuated at least at a detected trigger point of the first outer conductor of the first phase strand to close or open the third phase strand and to generate the third outer conductor.

2. The circuit arrangement according to claim 1, wherein the control unit comprises at least one sensor means, at least one calculating unit and/or at least one signal generator controllable by the calculating unit, by which a signal for opening or closing the switching element is able to be generated and passed and/or sent to the switching element.

3. The circuit arrangement according to claim 2, wherein the at least one sensor means comprises a synchronization circuit by which at least one positive/negative transition at the mains voltage input is able to be detected.

4. The circuit arrangement according to claim 2, wherein the calculating unit comprises a CPU and/or if the signal generator controllable by the calculating unit comprises a sinoidal pulse width modulation, wherein the calculating unit has an algorithm stored in the calculating unit for driving the signal generator, which comprises a sine function or relies on tables stored in the calculating unit.

5. The circuit arrangement according to claim 1, wherein the switching element has an output stage with at least one driver.

6. The circuit arrangement) according to claim 1, wherein the energy storage comprises at least one energy storage means and/or the energy storage comprises at least one transformer.

7. The circuit arrangement according to claim 6, wherein the energy storage comprises at least one rectifier arranged between the first phase strand and energy storage means and/or between the second phase strand and energy storage means.

8. The circuit arrangement according to claim 1, further comprising at least one measuring means arranged between the at least one switching element and the electrical consumer.

9. A method of operating a circuit arrangement for generating a three-phase rotating field according to claim 1, comprising the steps:
commissioning of the circuit arrangement by switching on or connecting the mains voltage input;
possibly charging the energy storage device through the mains voltage input;
detecting a suitable trigger point at least on the first outer conductor of the first phase strand by the by the sensor means of the control unit;
calculating an opening time of the switching element, in which a third outer conductor offset by 240° from the first outer conductor is able to be generated by the energy of the energy store, by the calculating unit of the control unit and by opening or closing the switching element by a signal generator of the control unit on reaching the opening or closing time.

10. The method according to claim 9, further comprising the steps:
depositing a run-up current in the calculating unit and/or detecting the run-up current by the measuring means;
limiting the run-up current by the control unit.
